(19) United States
(12) Patent Application Publication
(10) Pub. No.: US 2010/0011822 A1
(43) Pub. Date: Jan. 21, 2010

(54) ELECTROMECHANICAL CYLINDER FOR LOCK

(76) Inventor: Juan Imedio Ocaña, Oiartzun ( Guipuzcoa) (ES)

Correspondence Address: WENDEROTH, LIND & PONACK, L.L.P., 1030 15th Street, N.W.,, Suite 400 East, Washington, DC, 20005-1503, US

(21) Appl. No.: 12/502,319

(22) Filed: Jul. 14, 2009

(30) Foreign Application Priority Data
Jul. 15, 2008 (ES) P200802104

(51) Int. Cl. E05B 49/02

(52) U.S. Cl. 70/278.7

(57) ABSTRACT

The electromechanical cylinder is of the kind consisting of a knob (4) fixed to the cylinder body (5) fitted in the respective lock, in correspondence with the outer face of the latter, in other words it includes a single knob, with the particular feature that the rotor (6) which, together with the knob (4), form an electronic module, is located in a housing (15) of the cylinder body (5) and is retained therein axially but with the possibility of rotating freely, in such a way that in fitting the rotor (6) on the knob (4) the former remains in the inner and inaccessible part in order to prevent any manipulation thereof, this being a consequence of the fact that a base (7) forming the fastening element between the knob (4) and the cylinder body (5) is fixed by means of screws (38) which, in the assembly of the unit, remain facing in proximity to the actual door in which the lock is located, preventing such possible manipulations or violent acts.

### OBJECT OF THE INVENTION

As stated in the title of this descriptive specification, the present invention relates to an electromechanical cylinder for lock, intended for its application in virtually all mortise locks, replacing the mechanical cylinders, the cylinder furthermore being of the kind that includes just one knob.

The aim of the invention is to provide a cylinder for a lock with a single knob and which is applicable to the different types of lock to mortise, whether they be of the kind that use through cylinders, as in the case of European ones, or those that use half cylinders as in the case of American, Scandinavian and Australian locks. As well as the cylinder being valid with any kind of lock mentioned above, it also provides greater security against possible fraudulent manipulations or vandalism compared to conventional ones.

### BACKGROUND OF THE INVENTION

In the lock-making sector there exist locks that incorporate cylinders with two knobs, one on the inside and the other on the outside, in such a way that the knob on the inside houses the batteries along with the electronic control circuits and the electrical mechanism which carries out the opening control orders so as to activate a clutch or release a blocking, while the other knob, in other words the one on the outside, houses the proximity card reader.

In this type of cylinder with two knobs, there has to be an electrical connection between the two knobs running along the actual body of the cylinder, in which the body of the cylinder traverses the lock to mortise from the outer side to the inner.

The type of cylinder referred to generally corresponds to those of a European profile, which display the advantage that, due to having a double knob design, this facilitates the inclusion of all the components mentioned above, since there is more space in both knobs for housing them than exists just in the body of the cylinder. Moreover, the fact that the elements that decide and carry out the opening are on the inside makes this type of cylinder intrinsically very secure.

Nevertheless, the double knob design in cylinders displays the drawback that they cannot be used in locks that have an arrangement such that prevents the cylinder from traversing from one side to the other, corresponding in this case to American, Australian and Scandinavian mortise locks in which half cylinders are used, one on the outside and the other on the inside, and whose bodies or half cylinders do not traverse the lock from one side to the other.

So, in this type of lock the outside cannot be connected with the inside of the cylinder, therefore electronic or electromechanical double knob cylinders of the type described above cannot be fitted.

Another disadvantage of the type of cylinder that we are referring to is the complexity of its manufacture and installation owing to the need to electrically interconnect the reader for the outer knob with the inner knob, in which this electrical connection means that all the parts of the cylinder have to be fitted from the factory on a cylinder body with a length that is already determined.

Moreover, the actuator element of the cylinder for actuating the latch or bolt of the lock as it turns, in which this actuator element is traversed by the electrical connections mentioned above, has to be fitted from the factory, which makes it very difficult to exchange it later on in order to be able to adapt it to the different kinds of lock existing in the market.

In other words, the great variety of cylinder lengths and models of actuator elements makes it necessary to maintain a very large supply of all the varieties of product or otherwise to extend delivery periods. For the same reason, it makes it almost impossible to store cylinders in the distributor centers.

The drawbacks described above are solved by means of the electronic cylinder described in German patent DE10235201, which includes a single knob located on the outside, this knob housing the card reader, the control circuit, the batteries and the motor that drives the clutch mechanism, with which said knob solves the problem of locks that only admit half cylinders.

Nevertheless, this design of electronic cylinder described in that German patent has the drawback that the security of the system is compromised, since the motor element for driving the clutch mechanism is in the outer knob and could therefore easily become accessible by drilling or breaking the casing for the knob and engaging the cylinder by means of a simple manipulation of the motor, without the pertinent authorizations. Finally, it can be said that in relation to this electronic cylinder described in the German patent, given that the size of the knob cannot be very large and that it is very much fitted on the outside, it becomes very difficult to ensure protection that would prevent that kind of fraudulent access.

### DESCRIPTION OF THE INVENTION

The electromechanical cylinder for locks forming the object of the invention presents a series of innovations that permit the problems raised above to be solved, achieving great security in it.

In that regard, the inventive cylinder comprises a mechanical cylinder body which is what is fitted in the corresponding lock and an electronic module that can be coupled externally to the mechanical body of the cylinder, in which this electronic module in turn comprises a knob and a rotor.

In terms of the knob, this includes on its inside an external reader cover, a control circuit and some electrical supply batteries, while the rotor includes a drive motor and a clutch mechanism.

The electronic module of the cylinder is fixed to the body of the cylinder by means of introducing the rotor into a housing made for the purpose in that cylinder body, in such a way that in that assembly the electronic module with the rotor is able to turn freely with respect to the body of the cylinder fixed to the lock, but it is prevented from being displaced axially.

As a consequence of the fact that the rotor remains inside the body of the cylinder, the clutch mechanisms that are fitted in the actual rotor remain protected against any fraudulent physical manipulations, a protection that is provided for it by the actual security shield protecting the cylinder, being likewise protected against electronic manipulations.

The new design and characteristics referred to present a series of advantages with respect to conventional cylinders, among which the following can be cited as the most important:
It is a cylinder with a single knob located on the outside, which allows a half cylinder from any lock to be able to be fitted.
The manufacture and distribution of the cylinder are simplified since the rotors have basically the same dimensions in all cylinder types, so the electronic modules are always the same and can therefore be manufactured in large series runs.
It permits the manufacture of the cylinder body separately for each type and dimension of cylinder, in such a way that the cylinder body is a mechanical element and therefore economical, being easily decomposed into common subunits.
As a consequence of the advantages mentioned above, a large variety of models can be maintained without incurring major warehousing investments, such that when it comes to receiving orders it suffices to combine an electronic module with the appropriate model of the cylinder body, an operation that even be done in distribution centers for which no special knowledge or tools is required.
Finally, it can be said that as the sensitive segments, as are the motor and clutch, are arranged in the corresponding rotor of the cylinder body, a high level of security is maintained towards possible fraudulent or violent attacks.

### BRIEF DESCRIPTION OF THE DRAWINGS

In order to complement the description that is going to be made forthwith, and with the aim of facilitating a better understanding of the characteristics of the invention, this specification is accompanied by a set of drawings on the basis of which the innovations and advantages of the electromechanical cylinder for locks forming the inventive object will be more easily understood.

FIG. 1.- Shows a perspective view of a lock in which the inventive cylinder is applied with its electronic module arranged frontally and associated with the body of the cylinder fitted in the lock.

FIG. 2.- Shows an exploded perspective view of the different elements involved in the cylinder assembly of the invention.

FIG. 3.- Shows an exploded perspective view of what is considered to be an electromechanical assembly involving the fundamental elements of the rotor and the fastening base for the electronic module to the knob.

FIG. 4.- Shows a perspective view of the electromechanical cylinder constituted by the fastening between the knob and the body of the cylinder.

FIG. 5.- Shows a perspective view corresponding to an explosion of the two fundamental elements represented in the above figure.

FIG. 6.- Shows a perspective view of the electronic module in which the knob and the rotor can be seen, in position for being able to be coupled to different types of cylinder and lock, and which correspond to a cylinder of an American lock, a Scandinavian half cylinder, a European profile cylinder and to furniture lock, respectively.

### DESCRIPTION OF THE PREFERRED FORM OF EMBODIMENT

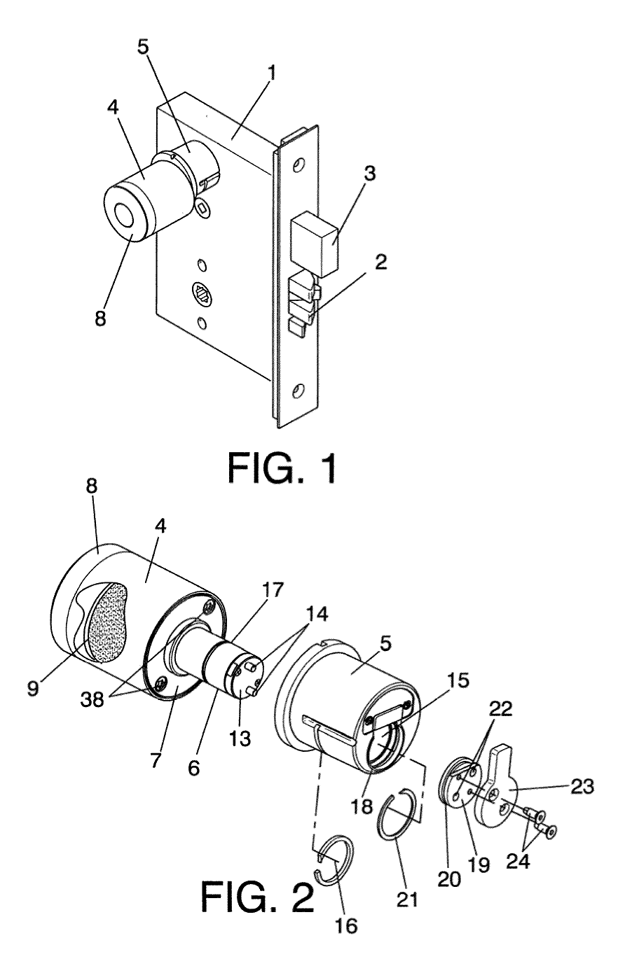

As can be seen in the figures referred to, and specifically in FIG. 1, the electromechanical cylinder is applied to a lock 1 with its corresponding latch 2 and bolt 3. In that FIG. 1, it can be seen how the electromechanical cylinder assembly fitted on the body of the lock 1 is differentiated from a purely mechanical one in that the knob occupies a position which would be occupied by the head of a mechanical key inserted in the cylinder.

Specifically, that electromechanical cylinder assembly 8 includes an electronic module comprising the knob 4 and an electromechanical assembly that will be explained further below, said knob of the electronic module being coupled to the body of the cylinder 5 applied to the lock 1.

The electromechanical assembly of the electronic module consists of a rotor 6 and a fastening base 7 for the actual knob 4, that base 7 being located in corresponding with the inner base or end, while provided on the outer base or end is a lid or cover 8 for the card reader, this cover or lid 8 being made of a plastic material in order to protect the appropriate proximity card reader, though it could also be made of metal in the event of using a contact electronic key reader.

Included inside the knob 4 is a control circuit 9, which also acts as a card reader, along with a battery 10 mounted on a battery-holder 11, likewise including in its interior a connector 12 as can be clearly seen in FIG. 5.

The inner end of the rotor 6 is provided with a closing cover 13 via which emerges a pair of retractile clutch pins 14 which, in the engaged position, project with respect to the cover 13, while in the non-operating position they remain withdrawn towards the inside and are therefore hidden behind said cover 13.

The body of the rotor 6 is mounted on a housing 15 established in the body of the cylinder 5, being retained in the latter by means of a ring 16, the rotor in this way being retained in the housing 15 of the cylindrical body 5, though able to rotate with respect to the latter. The ring 16 fits into an annular groove 17 provided for the purpose in the actual body of the rotor 6, as can be seen in FIG. 2.

Finally, the electronic module formed by the knob 4 and rotor 6 are axially fixed with respect to the body of the cylinder 5 and with the ability to rotate freely.

Provided on the inner end of the cylinder body 5, in other words on the end corresponding to the housing 15 not occupied by the end part of the rotor 6, is a groove 18 for the retention of a clutch disc 19 with an annular groove 20 in which is located a ring 21 for the retention of that clutch disc 19 in the mouth of the housing 5, when the ring 21 is located externally in the annular groove 18 mentioned above.

The clutch disc 19 contains a pair of holes 22 in which can be housed the clutch pins 14 when these emerge to the outside and, when the electronic module is turned, they cause an actuator element to rotate with it, this element being fixed by means of corresponding screws 24 to the actual clutch 19, in such a way that that actuator element 23 is what acts in the rotation on the latch 2 and/or on the bolt 3 of the lock 1.

In other words, by means of the interlocking between the clutch pins 14 and the hole 22 in the clutch disc 19, the latter is made to rotate and the latch 2 or bolt 3 are therefore actuated, while when the clutch pins 14 are retracted, the free rotation of the electronic module then takes place, in other words, the free rotation of the assembly formed by the knob 4 and the rotor 6, without the actuation of the lock being carried out. It must be borne in mind that the actuator element 23 can be easily exchanged simply by removing the screws 24 that fix it to the clutch disc 19, thereby permitting its adaptation to different makes of lock.

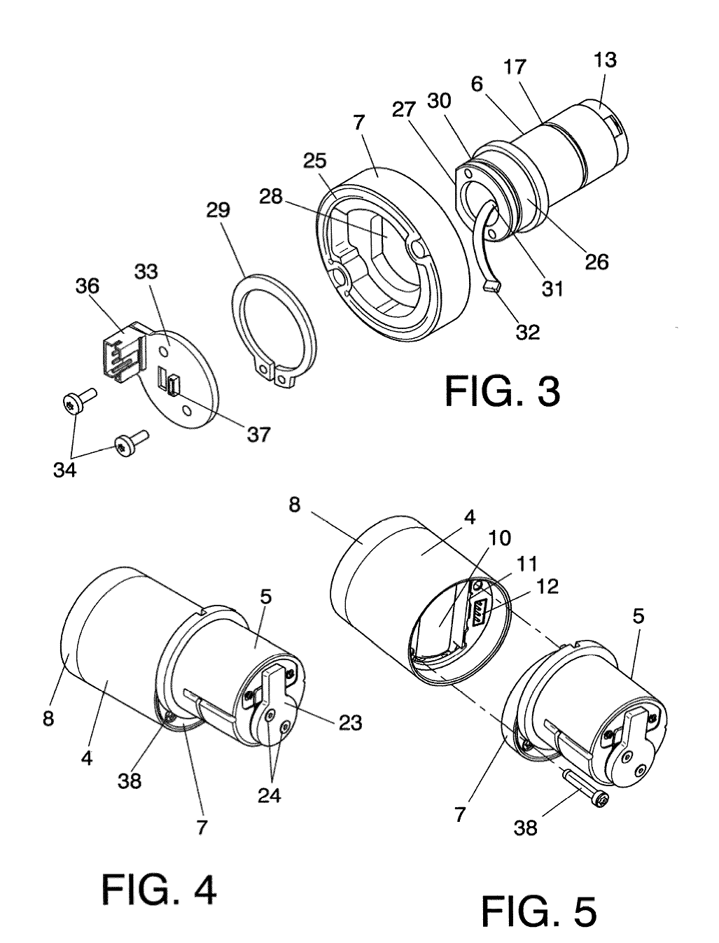

In terms of the electromechanical assembly represented in FIG. 3, and which includes the already mentioned rotor 6 and the fastening base 7, provided in the front face of the latter is a seal 25 for ensuring that the closure between it and the knob 4 is airtight, thus protecting the electronic elements from atmospheric humidity.

The end of the rotor opposite to that of the closing cover 13 has a neck 26 with a facing 27, corresponding in its outside with an opening 28 made in the forward face of the fastening base 7, that end part of the rotor 6 being fastened by means of a ring 29 which fits into a groove 30 provided for the purpose in this neck 26 mentioned above, with the particular feature that drill-proof protections, not represented, have been provided inside that neck 26 in order to protect the internal elements of the actual rotor 6, which becomes locked to the base 7 when the facing 27 of the former is offered to the facing of the opening 28 of that base 7, preventing the latter from being able to rotate with respect to the actual rotor 6 which, moreover, is complemented with a cable 31 which emerges via the end thereof and finishes in an end connector 32, with the corresponding signal lines permitting the control circuit 9 to control the circuit of the motor located in the interior of the actual rotor 6, provision having been made for the said connector 32 to be miniature so that it can pass through some labyrinths protecting the interior mechanisms of the actual rotor 6 with regard to possible improper manipulations.

In order to facilitate the operations of manufacture and maintenance, an interconnection circuit 33 has been provided, fixed by means of corresponding screws 34 to the end of the rotor 6, said circuit 33 presenting a pair of connectors 36 and 37 whose lines are connected together, the connector 37 corresponding to the connector 32 of the rotor 6, the two being connected at the moment of manufacture and they will not have to be disconnected throughout the entire life of the cylinder, while the connector 36 corresponds to the connector 12 of the knob 4, in such a way that when the latter is mounted on the base 7 there just exists one possible position thanks to a notch in the circumference of both pieces so that the two connectors remain aligned together. Said pair of connectors facilitate the operation of changing the batteries 10 in which the knob 4 has to be detached from the rest of the cylinder after first removing the fastening screws 38.

In order to increase the security of the system and prevent anyone who can access the connection cables between both circuits from being able to simulate the opening order, a process of authentication has been established in each opening order in which the control circuit 9 has to give the coded order with the corresponding random number previously generated by the clutch mechanism control, using certain keys known only by both circuits.

Although the invention has been described for being used on a half cylinder in American type mortise locks, it can also be used on other kinds of lock or cylinder, always provided they have a housing for the rotor and a clutch disc like those mentioned.

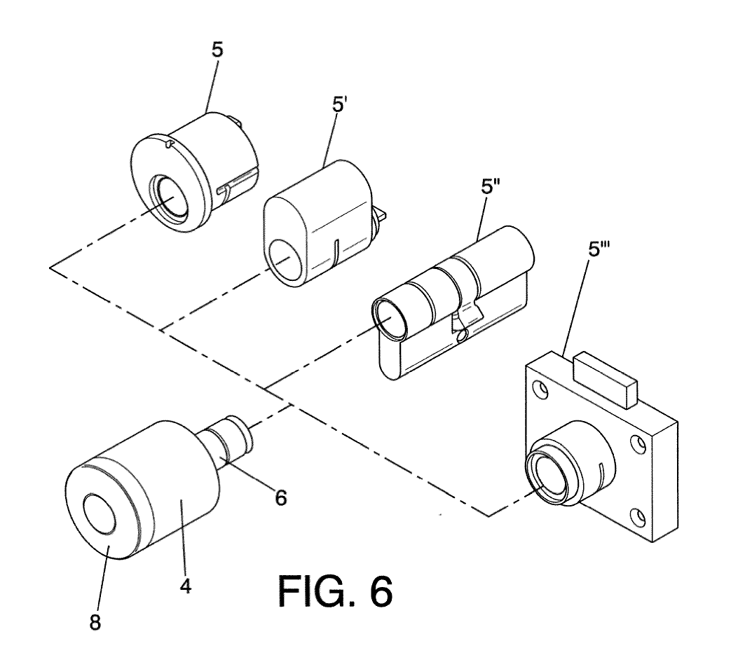

So, in FIG. 6 can be seen an electronic module forming by the knob 4 and the rotor 6, in the position of being able to be coupled to different types of cylinder bodies, 5, 5′, 5″ and 5″′, corresponding to different locks, as might be in the first case a cylinder for an American lock, in the second a cylinder for a Scandinavian type lock, in the third case for a European lock cylinder and in the last case for a cylinder for a furniture lock.

The actuator element 23 is interchangeable in the clutch disc 19, and therefore permits the coupling of different actuator elements depending on the lock in which the electromechanical cylinder of this invention is fitted. Said actuator element 23 can be an eccentric, a tongue, a square bar or a shaft, depending on the opening characteristics of the lock where it is fitted.

1. Electromechanical cylinder for lock, which, being applicable to any kind of lock that incorporates a single knob established in correspondence with the outside part, is characterized in that it is created starting from an electronic module able to be coupled to the body of the cylinder (5) mounted on the corresponding lock (1) to which it is fitted, said electronic module comprising the respective knob (4) and a rotor (6) fixed to each other, with the particular feature that the knob (4) includes an outer cover (8) as a card reader, a control circuit (9) for the functioning of the assembly, and electrical supply batteries (10), while the rotor (6) includes an actuation motor and a clutch mechanism whose pins (14) are suitable for coupling to a clutch disc (19) on which is in turn fixed, and externally, an actuator element (23) for actuating the corresponding latch (2) and/or bolt (3) of the lock (1), furthermore comprising a control circuit for the functioning of said clutch mechanism.

2. Electromechanical cylinder for lock, according to claim 1, characterized in that the coupling between the knob (4) of the electronic module and the cylinder body (5) causes the rotor (6) of the former to become located in a housing (15) established in the cylinder body (5), in such a way that said rotor (6) with the knob (4) remains axially retained with respect to the cylinder body (5) but with the ability to rotate freely with respect to it, the clutch mechanism remaining protected inside the rotor (6).

3. Electromechanical cylinder for lock, according to the above cams claim 1, characterized in that the rotor (6) is coupled via its ends to the knob (4) with the interposition of a fastening base (7) and in correspondence with the side facing the corresponding lock (1), while the other end of that rotor (6) is retained in the housing (15) provided inside the cylinder body (5).

4. Electromechanical cylinder for lock, according to claim 1, characterized in that it includes a data verification system between the control circuit (9) and the clutch mechanism control.

5. Electromechanical cylinder for lock, according to claim 1, characterized in that the clutch mechanism consists of retractile pins (14) corresponding to the rotor (6), suitable for being housed in holes (22) of a clutch disc (19) which is retained in the end of the housing (15) of the actual rotor (6), to which disc (19) is fixed an actuator element (23) whose rotation in carrying out the clutch engagement entails the actuation of the latch (2) and/or bolt (3) of the lock (1).

6. Electromechanical cylinder for lock, according to claim 1, characterized in that the electrical supply battery (10) is interchangeable following detachment of the cylinder assembly from the lock (1) and then of the knob (4) from the base (7).

7. Electromechanical cylinder for lock, according to claim 1, characterized in that the rotor (6) displays a cylindrical configuration with a diameter and lengths that permit it to be mounted in any lock cylinder (5, 5′, 5″, 5″′).

8. Electromechanical cylinder for lock, according to the above claim 1, characterized in that the actuator element (23) is interchangeable in the clutch disc (19) depending on the lock, said actuator element (23) being able to have the shape of an eccentric, a tongue, a square bar or a shaft.

9. Electromechanical cylinder for lock, according to claim 2, characterized in that the rotor (6) is coupled via its ends to the knob (4) with the interposition of a fastening base (7) and in correspondence with the side facing the corresponding lock (1), while the other end of that rotor (6) is retained in the housing (15) provided inside the cylinder body (5).

10. Electromechanical cylinder for lock, according to claim 2, characterized in that it includes a data verification system between the control circuit (9) and the clutch mechanism control.

11. Electromechanical cylinder for lock, according to claim 3, characterized in that it includes a data verification system between the control circuit (9) and the clutch mechanism control.

12. Electromechanical cylinder for lock, according to claim 2, characterized in that the clutch mechanism consists of retractile pins (14) corresponding to the rotor (6), suitable for being housed in holes (22) of a clutch disc (19) which is retained in the end of the housing (15) of the actual rotor (6), to which disc (19) is fixed an actuator element (23) whose rotation in carrying out the clutch engagement entails the actuation of the latch (2) and/or bolt (3) of the lock (1).

13. Electromechanical cylinder for lock, according to claim 3, characterized in that the clutch mechanism consists of retractile pins (14) corresponding to the rotor (6), suitable for being housed in holes (22) of a clutch disc (19) which is retained in the end of the housing (15) of the actual rotor (6), to which disc (19) is fixed an actuator element (23) whose rotation in carrying out the clutch engagement entails the actuation of the latch (2) and/or bolt (3) of the lock (1).

14. Electromechanical cylinder for lock, according to claim 4, characterized in that the clutch mechanism consists of retractile pins (14) corresponding to the rotor (6), suitable for being housed in holes (22) of a clutch disc (19) which is retained in the end of the housing (15) of the actual rotor (6), to which disc (19) is fixed an actuator element (23) whose rotation in carrying out the clutch engagement entails the actuation of the latch (2) and/or bolt (3) of the lock (1).

15. Electromechanical cylinder for lock, according to claim 2, characterized in that the electrical supply battery (10) is interchangeable following detachment of the cylinder assembly from the lock (1) and then of the knob (4) from the base (7).

16. Electromechanical cylinder for lock, according to claim 3, characterized in that the electrical supply battery (10) is interchangeable following detachment of the cylinder assembly from the lock (1) and then of the knob (4) from the base (7).

17. Electromechanical cylinder for lock, according to claim 4, characterized in that the electrical supply battery (10) is interchangeable following detachment of the cylinder assembly from the lock (1) and then of the knob (4) from the base (7).

18. Electromechanical cylinder for lock, according to claim 5, characterized in that the electrical supply battery (10) is interchangeable following detachment of the cylinder assembly from the lock (1) and then of the knob (4) from the base (7).

19. Electromechanical cylinder for lock, according to claim 2, characterized in that the rotor (6) displays a cylindrical configuration with a diameter and lengths that permit it to be mounted in any lock cylinder (5, 5′, 5″, 5″′).

20. Electromechanical cylinder for lock, according to claim 3, characterized in that the rotor (6) displays a cylindrical configuration with a diameter and lengths that permit it to be mounted in any lock cylinder (5, 5′, 5″, 5″′).

21. Electromechanical cylinder for lock, according to claim 4, characterized in that the rotor (6) displays a cylindrical configuration with a diameter and lengths that permit it to be mounted in any lock cylinder (5, 5′, 5″, 5″′).

22. Electromechanical cylinder for lock, according to claim 5, characterized in that the rotor (6) displays a cylindrical configuration with a diameter and lengths that permit it to be mounted in any lock cylinder (5, 5′, 5″, 5″′).

23. Electromechanical cylinder for lock, according to claim 6, characterized in that the rotor (6) displays a cylindrical configuration with a diameter and lengths that permit it to be mounted in any lock cylinder (5, 5′, 5″, 5″′).

24. Electromechanical cylinder for lock, according to claim 2, characterized in that the actuator element (23) is interchangeable in the clutch disc (19) depending on the lock, said actuator element (23) being able to have the shape of an eccentric, a tongue, a square bar or a shaft.

25. Electromechanical cylinder for lock, according to claim 3, characterized in that the actuator element (23) is interchangeable in the clutch disc (19) depending on the lock, said actuator element (23) being able to have the shape of an eccentric, a tongue, a square bar or a shaft.

26. Electromechanical cylinder for lock, according to claim 4, characterized in that the actuator element (23) is interchangeable in the clutch disc (19) depending on the lock, said actuator element (23) being able to have the shape of an eccentric, a tongue, a square bar or a shaft.

27. Electromechanical cylinder for lock, according to claim 5, characterized in that the actuator element (23) is interchangeable in the clutch disc (19) depending on the lock, said actuator element (23) being able to have the shape of an eccentric, a tongue, a square bar or a shaft.

28. Electromechanical cylinder for lock, according to claim 6, characterized in that the actuator element (23) is interchangeable in the clutch disc (19) depending on the lock, said actuator element (23) being able to have the shape of an eccentric, a tongue, a square bar or a shaft.

29. Electromechanical cylinder for lock, according to claim 7, characterized in that the actuator element (23) is interchangeable in the clutch disc (19) depending on the lock, said actuator element (23) being able to have the shape of an eccentric, a tongue, a square bar or a shaft.
